(19) United States
(12) Patent Application Publication
(10) Pub. No.: US 2013/0326125 A1
(43) Pub. Date: Dec. 5, 2013

(54) FLASH MEMORY APPARATUS AND DATA ACCESS METHOD FOR FLASH MEMORY WITH REDUCED DATA ACCESS TIME

(71) Applicant: Silicon Motion Inc., Hsinchu County (TW)

(72) Inventors: Hsiao-Te Chang, Hsinchu County (TW); Chun-Yi Chen, Chiayi City (TW)

(21) Appl. No.: 13/909,106

(22) Filed: Jun. 4, 2013

Related U.S. Application Data
(60) Provisional application No. 61/654,964, filed on Jun. 4, 2012.

(30) Foreign Application Priority Data
May 17, 2013 (TW) 102117641

(51) Int. Cl. G06F 12/02

(52) U.S. Cl. CPC G06F 12/0246
USPC 711/103

(57) ABSTRACT

A data access method for flash memory includes: receiving a first data from a host terminal by utilizing a flash memory controller; transmitting and writing the first data into a single-level cell of the flash memory form the flash memory controller; and when the flash memory controller receives a second data from the host terminal, utilizing the flash memory controller to execute a copy back program to merge at least a portion of the first data stored in the single-level cell into a multi-level cell.

### CROSS REFERENCE TO RELATED APPLICATIONS

This application claims the benefit of U.S. provisional application No. 61/654,964, filed on Jun. 4, 2012 and incorporated herein by reference.

### BACKGROUND OF THE INVENTION

1. Field of the Invention

The disclosed embodiments of the present invention relate to a data access mechanism of flash memories, and more particularly, to a data access method for a flash memory and a related flash memory apparatus.

2. Description of the Prior Art

Generally speaking, in order to increase the storage capacity, prior arts often apply multi-level storage components to implement flash memories. Multi-level storage components could be, for example, multi-level cells (MLCs) or triple-level cells (TLCs). However, although using the multi-level storage components has a benefit of enlarged storage capacity, it takes more data read/write time in a relative view. In other words, flash memories with multi-level storage components have a lower overall efficiency. If the flash memory data access efficiency is low, the host terminal has to wait for the completion of a memory writing process each time a user writes a data to the flash memory via the flash memory controller. After that, the host terminal is allowed to perform a next memory writing process. Therefore, a much longer wait time is required for the user if he/she needs to write a series of data into the flash memory. That is to say, although using the multi-level storage achieves a larger storage capacity, it also has shortcomings such as lower data access efficiency and longer data access time.

### SUMMARY OF THE INVENTION

Therefore, one of the objectives of the present invention is to provide a data access method for a flash memory and a related flash memory apparatus to solve the aforementioned issues.

According to an embodiment of the present invention, a data access method for flash memory is disclosed. The data access method includes: receiving a first data from a host terminal by utilizing a flash memory controller; transmitting and writing the first data into a single-level cell of the flash memory form the flash memory controller; and when the flash memory controller receives a second data from the host terminal, utilizing the flash memory controller to execute a copy back program to merge at least a portion of the first data stored in the single-level cell into a multi-level cell.

According to another embodiment of the present invention, a flash memory apparatus is disclosed. The flash memory apparatus includes a flash memory and a flash memory controller. The flash memory is arranged for storing data. The flash memory controller is coupled to the flash memory and is arranged for receiving a first data from a host terminal, and transmitting and writing the first data from the flash memory controller into a single-level cell of the flash memory. Wherein when the flash memory controller receives a second data from the host terminal, utilizing the flash memory controller to execute a copy back program to merge at least a portion of the first data stored in the single-level cell into a multi-level cell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a flash memory apparatus according to a preferred embodiment of the present invention.

FIG. 2 is a timing diagram illustrating data writing process of the flash memory apparatus shown in FIG. 1 according to a first embodiment of the present invention.

FIG. 3 is a timing diagram illustrating data writing process of the flash memory apparatus shown in FIG. 1 according to a second embodiment of the present invention.

FIG. 4 is a timing diagram illustrating data writing process of the flash memory apparatus shown in FIG. 1 according to a third embodiment of the present invention.

FIG. 5 is a timing diagram illustrating data writing process of the flash memory apparatus shown in FIG. 1 according to a fourth embodiment of the present invention.

FIG. 6 is a timing diagram illustrating data writing process of the flash memory apparatus shown in FIG. 1 according to a fifth embodiment of the present invention.

FIG. 7 is a timing diagram illustrating data writing process of the flash memory apparatus shown in FIG. 5 according to a another embodiment of the present invention.

FIG. 8A is a timing diagram illustrating a data writing process of the flash memory apparatus shown in FIG. 1 that writes data without a data cache process according to an embodiment of the present invention.

FIG. 8B is a timing diagram illustrating a data writing process of the flash memory apparatus shown in FIG. 1 that writes data through a data cache process according to an embodiment of the present invention.

FIG. 9 is a timing diagram illustrating a data writing process of the flash memory apparatus shown in FIG. 1 according to an embodiment of the present invention.

FIG. 10 is a timing diagram illustrating a data writing process of the flash memory apparatus shown in FIG. 1 according to another embodiment of the present invention.

FIG. 11 is a timing diagram illustrating a data writing process of the flash memory apparatus shown in FIG. 1 according to yet another embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

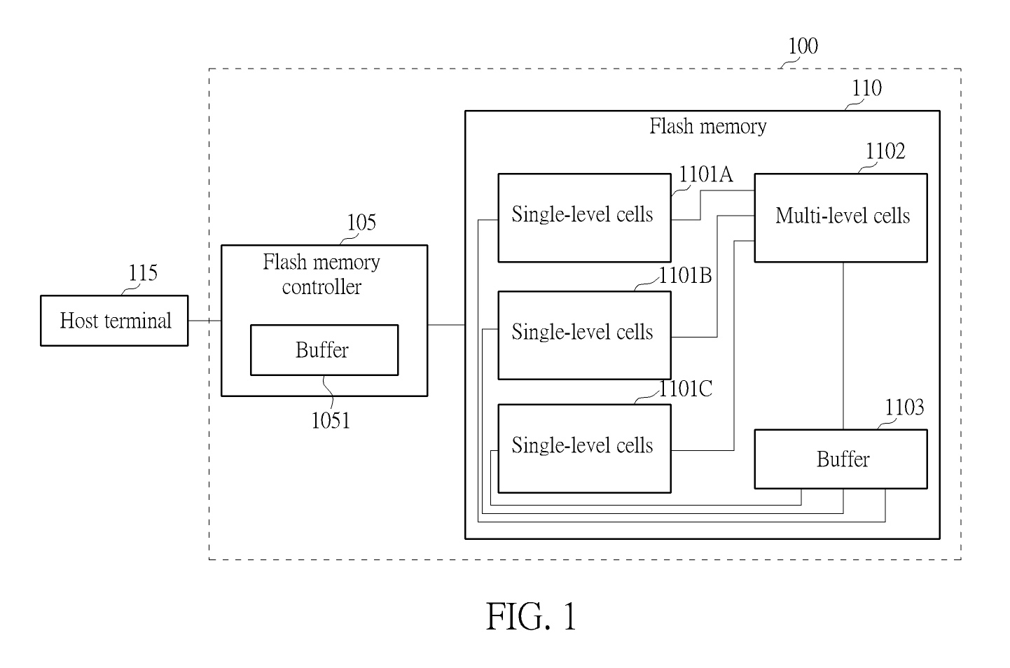

Please refer to FIG. 1, which is a diagram illustrating a flash memory apparatus 100 according to a preferred embodiment of the present invention. The flash memory apparatus 100 includes a flash memory controller 105 and a flash memory 110. The flash memory apparatus 100 is externally connected to a host terminal 115. The flash memory controller 105 includes a buffer 1051. The flash memory 110 includes a plurality of single-level cells (SLCs) 1101A-1101C, a plurality of multi-level cells (MLCs) 1102 (only one is illustrated in FIG. 1 for representative purpose), and a buffer 1103 (which may have a built-in data cache mechanism). When a data is stored in the flash memory 110, the data is stored in multiple MLCs 1102. In this embodiment, each MLC 1102 is a triple-level cell (TLC), and collaborates with three SLCs 1101A-1101C to achieve a higher data access speed. However, this is not a limitation of the present invention. In other embodiments, each MLC 1102 may be a multi-level cell with two levels, and collaborate with two SLCs 1101A-1101B to achieve a higher data access speed. In other words, the present invention does not restrict the number of SLCs or the levels of each MLC. Any feasible designs all belong to the scope of the present invention.

For the data writing process, the host terminal 115 first transmits a write command to the flash memory controller 105, so as to notify the flash memory controller 105 that a data writing process is going to be performed. Meanwhile, the host terminal 115 transmits the data to be written to the flash memory controller 105, where the data is then temporarily buffered in the buffer 1051. After that, the flash memory controller 105 transmits the data buffered in the buffer to the flash memory 110. According to the embodiment of the present invention, in order to reduce the data writing time of the flash memory controller 105 and improve the efficiency, when the flash memory controller 105 writes the data temporarily buffered in the buffer 1051 into the flash memory 110, the data is first written into the SLC 1101A-1101C and then merged into the TLC 1102. When the flash memory controller 105 performs the merging operation upon the flash memory 110, the data is read from the SLCs 1101A-1101C and temporarily stored into the buffer 1103 of the flash memory 110. Next, the data is transferred from the buffer 1103 to the TLC 1102. In other words, the merging operation for the data writing process is achieved by utilizing the buffer 1103 of the flash memory 110 without occupying the storage capacity of the buffer 1051 of the flash memory controller 105. Therefore, while the aforementioned merging operation for the data writing process is being performed, the flash memory controller 105 is able to buffer and temporarily store the next data coming from the host terminal 115 through the buffer 1051. Thus, the flash memory controller 105 does not spend time on waiting for the completion of the data writing of the TLC 1102. Instead, the flash memory controller 105 buffers the next data at the same time the data writing of the TLC 1102 is active. Therefore, the flash memory controller 105 has higher overall efficiency, so as to allow the flash memory 100 to meet a higher-level transmission specification, such as the flash memory class 4 standard with a data read/write rate of 4 MB/s.

The specific implementation of the proposed method of the prevent invention is described as follows. For example, the host terminal 115 transmits a first write data, a second write data, a third write data into the flash memory controller 105, sequentially. For each write data, the flash memory controller 105 receives the write data first, and writes the received write data into an SLC of the flash memory 110. For instance, the flash memory controller 105 writes the first write data into an SLC (one of SLCs 1101A-1101C). After that, the flash memory controller 105 receives the second write data. While receiving the second write data, the flash memory controller 105 starts to execute a copy back program of the flash memory 110 to merge at least a portion of the first write data stored in the SLC into an MLC 1102 of the flash memory 110, wherein the copy back program realizes the merging operation through the buffer 1103. That is to say, the buffer 1051 of the flash memory controller 105 is left irrelevant and unoccupied in the merging operation for the writing data process. It should be noted that, in this embodiment, the storage cells of the flash memory 110 are TLCs, and the at least a portion of the first write data is at least one of a least significant bit (LSB), a central significant bit (CSB), or a most significant bit (MSB) of the first write data. In other words, a portion of the write data includes LSB, CSB, or MSB data. Please note that the operation of merging the LSB, CSB, and MSB data can be regarded as the first, the second, and the third merging operations. However, regarding the data writing order, the above operations do not write the merged data into the same word line, but are based on a specific order for data merging. Since this is not the focus of the present invention, the details thereof are omitted here for brevity.

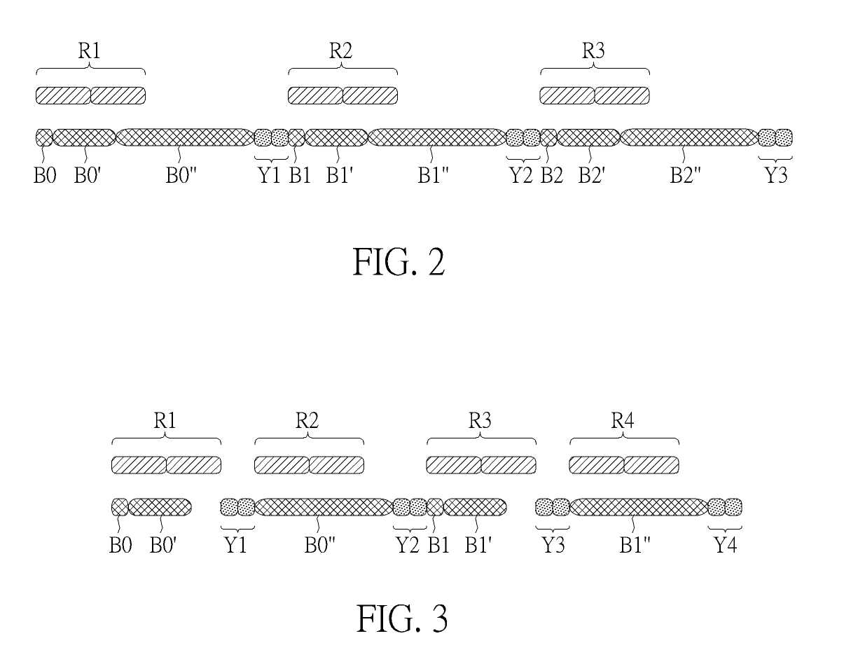

Please refer to FIG. 2, which is a timing diagram illustrating data writing process of the flash memory apparatus 100 shown in FIG. 1 according to a first embodiment of the present invention. As shown in FIG. 2, the regions R1-R3 marked by slashes are representative of time periods of temporarily storing a data into the buffer 1051 of the flash memory controller 105 by the host terminal 115 in accordance with a data write command. For instance, the data may be two 16 KB data. In other words, the host terminal 115 moves 32 KB data to the buffer 1051 by performing the data write command. Regions Y1-Y3 marked by dots are time periods required for the flash memory controller 105 to respectively transfer and write the temporarily buffered data into the SLC of the flash memory 110. The regions marked by cross-lines are time periods required for the flash memory 110 to respectively start the copy back program and execute the data writing process, wherein B0, B1, B2 are required time periods for the first merging operation (which writes the LSB), and B0′, B1′, B2′ are required time periods for the second merging operation (which writes the CSB), and B0″, B1″, B2″ are required time periods for the third merging operation (which writes the MSB). As shown in FIG. 2, at time point t1, the host terminal 115 executes 32 KB data writing process through a data write command, and transfers the 32 KB data R1 to the flash memory controller 105. At the same time, the copy back program of the flash memory 110 is started, and three merging operations for the data writing process are performed such that the previous data stored in the SLC is merged into the TLC. B0, B0′, B0″ are required time periods for merging the previous data from the SLC to the TLC (i.e., required time periods for writing the LSB, the CSB and the MSB, respectively). Once the MSB data is merged completely, the flash memory controller 105 transfers the buffered 32 KB data to the flash memory 115. Y1 is the required time period for transferring and writing the data. After the end of Y1, the host terminal 115 transfers and writes a next data R2 into the buffer 1051 through a next data write command at time point t2; meanwhile, the copy back program of the flash memory 110 is started, and three merging operations for the data writing process are performed such that the previous data stored in the SLC is merged into the TLC. B0, B0′, B0″ are required time periods for merging the previous data from the SLC to the TLC, and so on. As can be seen from above descriptions, in the embodiment shown in FIG. 2, the time period of the host terminal 115 transferring and writing a data into the buffer 1051 through the data write command respectively overlaps with the time periods of the three merging operations. That is to say, when a data is transferred and written into the buffer 1051, a merging and writing operation is performed at the same time. It should be noted that the SLC data writing process is performed after the three copy back programs are completed in the flash memory 110 according to the embodiment shown in FIG. 2. However, this is not a limitation of the present invention. Further, if data received during time period R1 and time period R2 are the first data and the second data respectively, then the time point (the starting time point of R2) when the flash memory controller 105 starts to receive a second data from the host terminal 115 is substantially equal to the time point (the starting time point of B1) when the flash memory controller 105 starts to perform the copy back program for merging and writing at least a portion of the first data stored in the SLC into the MLC.

Besides, in other embodiments, the time period in which the host terminal 115 transfers and writes 32 KB data into the buffer 1051 through the data write command could overlap with the time periods of only two merging and writing processes. For instance, when a data is transferred and written into the buffer 1051, the first and second merging and writing processes are performed for writing the LSB data and the CSB data. The third merging process (which writes the MSB data) then will be executed when the next 32 KB data is transferred and written into the buffer 1051. Please refer to FIG. 3, which is a timing diagram illustrating data writing process of the flash memory apparatus 100 shown in FIG. 1 according to a second embodiment of the present invention. As shown in FIG. 3, at time point t1, the host terminal 115 performs the 32 KB data writing process through a data write command, so as to transfer the 32 KB data R1 into the flash memory controller 105. At the same time, the copy back program of the flash memory 110 is started and two merging operations for data writing process are performed, wherein the previous LSB data and CSB data stored in the SLC are merged into the TLC. B0 and B0′ are required time periods for merging the previous 32 KB data from the SLC to the TLC. In this example, the required time for the two merging and writing processes is less than R1. Therefore, the flash memory controller 105 transfers and writes the 32 KB data temporarily stored in the buffer 1051 into the flash memory 110 after R1. Y1 is the required time period for transferring and writing the data. After Y1, the host terminal 115 transfers and writes a next 32 KB data into the buffer 1051 within the time period R2 through a next data write command; meanwhile, the copy back program of the flash memory 110 is started again, and the third merging operation for the data writing process is performed. So the previous MSB data stored in the SLC is merged into the TLC. B0″ is a required time period for merging the previous data from the SLC to the TLC. Due to the fact that B0″>R2, after the end of B0″, the flash memory controller 105 is allowed to transfer and write the 32 KB data transferred within the time period R2 into the flash memory 110 from the buffer 1051, and so on. As can be seen from above descriptions, in the embodiment shown in FIG. 3, the required time for three merging and writing processes respectively overlaps with the time periods of the two merging and writing processes. It should be noted that the SLC data writing process is performed after the two copy back programs (i.e., the first and the second merging and writing processes) are completed in the flash memory 110 according to the embodiment shown in FIG. 3, and then the third merging and writing process is performed. However, this is not a limitation of the present invention.

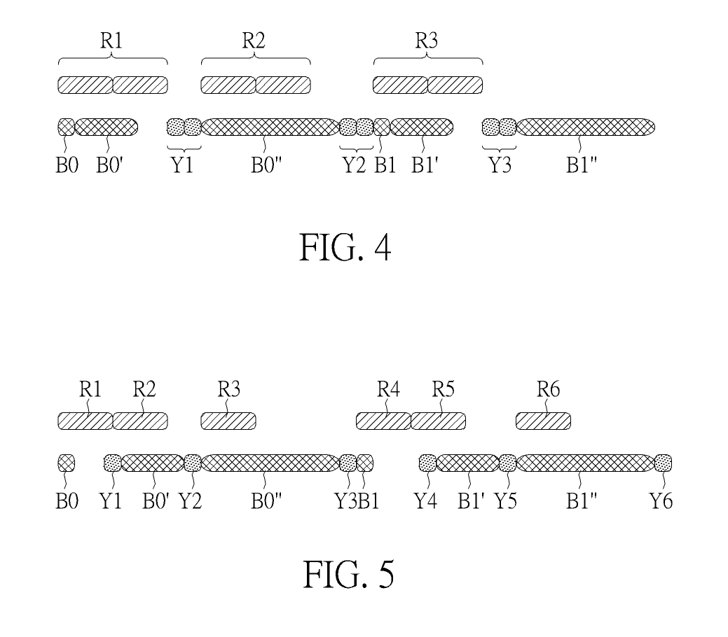

Please refer to FIG. 4, which is a timing diagram illustrating data writing process of the flash memory apparatus 100 shown in FIG. 1 according to a third embodiment of the present invention. The difference between the embodiments shown in FIG. 4 and FIG. 3 is that the required time period for the copy back program of the flash memory 110 to execute the third merging and writing process in FIG. 4 is shorter. As shown in FIG. 4, the time period B0″ is shorter than the transferring time period R2. Therefore, after the end the transferring time period R2, the flash memory controller 105 is allowed to transfer and write the 32 KB data transferred within the time period R2 into the flash memory 110 from the buffer 1051 (the required time is marked as Y2), and so on. It should be noted that the SLC data writing process is performed after the two copy back programs (i.e., the first and the second merging and writing processes) are completed in the flash memory 110 according to the embodiment shown in FIG. 4, and then the third merging and writing process is performed. However, this is not a limitation of the present invention.

Furthermore, the present invention has no limitation on the size of one data. In other embodiments, the size of one data may be only 16 KB rather than 32 KB. Therefore, a 16 KB data writing process is performed when a data write command is sent from the host terminal 115 to the flash memory controller 105. For example, please refer to FIG. 5, which is a timing diagram illustrating data writing process of the flash memory apparatus 100 shown in FIG. 5 according to a fourth embodiment of the present invention. As shown in FIG. 5, the host terminal 115 transfers and writes a data into the buffer 1051 within time period R1; meanwhile, the flash memory 110 starts the first merging and writing process to copy back LSB data of the previous data from the SLC to the TLC within time period B0. After the end of time period R1, the flash memory controller 105 then writes the temporarily stored data (corresponding to the data transferred in time period R1) into the SLC of the flash memory 110, where Y1 is the required time period for transferring and writing the data. At the same time, the flash memory controller 105 also receives and buffers the next 16 KB data (the corresponding transferring time is marked as R2). After the end of Y1, the flash memory 110 starts the copy back process to execute the second merging and writing process to write the CSB of the previous data into the SLC, wherein the required time period is marked as B0′. After the end of B0′, one data from the flash memory controller 105 is stored into the SLC of the flash memory 110, wherein the data transferring and writing time is marked as Y2. After the end of Y2, the host terminal 115 transfers and writes a next 16 KB data into the buffer 1051 within time period R3; meanwhile, the flash memory 110 starts the copy back program through time period B0″ to execute the third merging and writing process. After the end of B0″, the SLC of the flash memory 110 receives and stores a 16 KB data coming from the flash memory controller 105. In other words, in this embodiment, when the host terminal 115 sends a data write command to perform a 16 KB data writing process, the flash memory 110 substantially simultaneously performs a merging and writing process, thus saving the overall data transferring and writing time. For instance, the flash memory 110 may simultaneously perform the merging and writing process. Or in another case, the flash memory 110 may perform the merging and writing process slightly later. In addition, the flash memory controller 105 writes the previous data temporarily stored therein into the flash memory 110 and receives and buffers the next data coming from the host terminal 115 at the same time, which also helps to reduce the data transferring and writing time. For instance, the flash memory controller 105 receives the next data from the host terminal 115 at time period R2, and substantially simultaneously (simultaneously or slightly later) transfers and writes the currently buffered data into the SLC of the flash memory 110 at time period Y1. It should be noted that, according to the embodiment shown in FIG. 5, the SLC data writing process is performed after the flash memory 110 performs a single merging and writing process; after that, the next merging and writing process will be performed. However, this is not a limitation of the present invention.

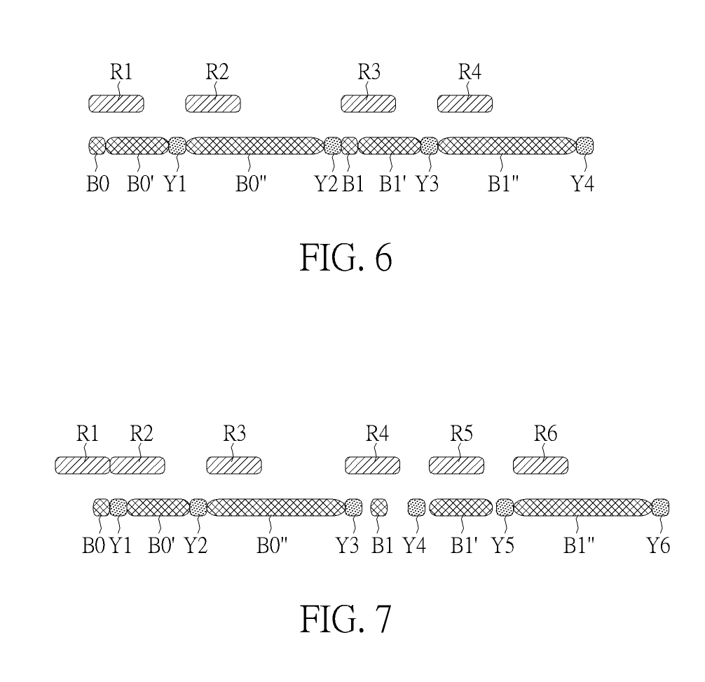

Please refer to FIG. 6, which is a timing diagram illustrating data writing process of the flash memory apparatus 100 shown in FIG. 1 according to a fifth embodiment of the present invention. As shown in FIG. 6, when the host terminal 115 transfers and writes a 16 KB data into the flash memory controller 105, the flash memory 110 starts the copy back program to execute the first two merging and writing processes at the same time, so as to write the LSB and the CSB data into the TLC from the SLC. After the end of the merging and writing process of the CSB data, the SLC of the flash memory 110 receives the data coming from the flash memory 105 (the required time period is marked as Y1). After the end of Y1, the flash memory controller 105 receives and temporarily stores the next 16 KB data coming from the host terminal 115 (the required time period for transferring and writing the data is marked as R2); meanwhile, the flash memory controller 105 starts the copy back program of the flash memory 110 to execute the third merging and writing process for merging and writing the MSB data to the TLC from the SLC. After the merging and writing process for the MSB is over, the SLC of the flash memory 110 receives the data coming from the flash memory 105 (the required time period is marked as Y2). After the end of Y2, the flash memory controller 105 receives and temporarily stores the next 16 KB data coming from the host terminal 115 (the required time period for transferring and writing the data is marked as R3), and so on. It should be noted that the SLC data writing process is performed after the two copy back programs (i.e., the first and the second merging and writing processes) are completed in the flash memory 110 according to the embodiment shown in FIG. 6, and then the third merging and writing process is performed. However, this is not a limitation of the present invention.

Please refer to FIG. 7, which is a timing diagram illustrating data writing process of the flash memory apparatus 100 shown in FIG. 5 according to a sixth embodiment of the present invention. As shown in FIG. 7, when the host terminal 115 transfers and writes one data into the flash memory controller 1051 through the time period R1, the flash memory 110 starts the first merging and writing process at the same time, to copy and write the LSB data of the previous data into the TLC from the SLC before the time period B0. After the end of R1, the flash memory controller 105 writes the stored data (transferred at the time corresponding to R1) into the SLC of the flash memory 110, where the required time period is Y1. Meanwhile, after the end of R1, the flash memory controller 105 also receives and temporarily stores the next 16 KB data coming from the host terminal 115 (the required time period for transferring and writing the data is marked as R2). After the end of Y1, the flash memory 110 starts the copy back program to execute the second merging and writing process, to merge and write the CSB of the previous data into the TLC, where the required time period is marked as B0′. After the end of B0′, the SLC of the flash memory 110 then stores one data coming from the flash memory controller 105, where the required time period for transferring and writing the data is marked as Y2. After the end of Y2, the host terminal 115 transfers and writes the next 16 KB data into the buffer 1051; meanwhile, the flash memory 110 starts the copy back program at time period B0″ to execute the third merging and writing process. After the end of B0″, one 16 KB data coming from the flash memory controller 105 is received and then stored into the SLC of the flash memory 110, where the required time period is marked as Y3. At the same time, the flash memory controller 105 receives and temporarily stores the next 16 KB data coming from the host terminal 115 at time period R4 by utilizing the buffer 1051, wherein the time period R4 partially overlaps with the time period R3. It should be noted that the SLC data writing process is performed after a single copy back program is completed in the flash memory 110 according to the embodiment shown in FIG. 7, and then the next merging and writing process is performed. However, this is not a limitation of the present invention.

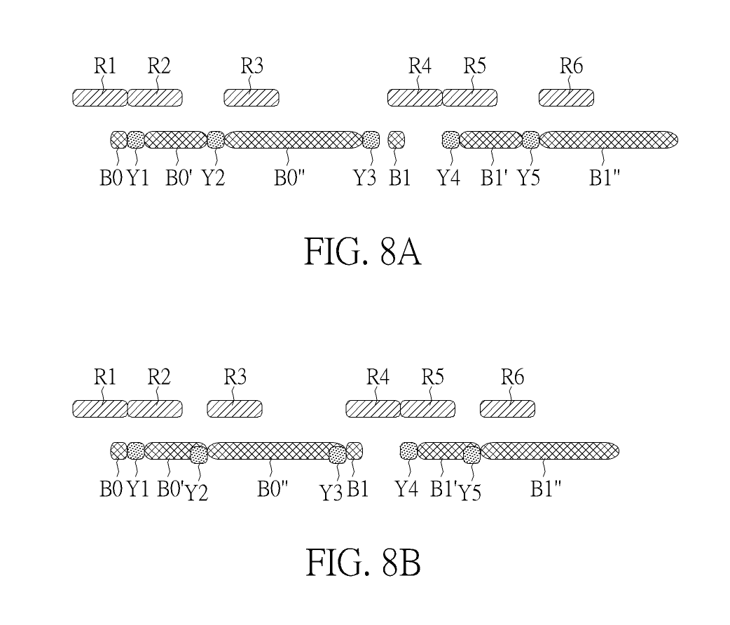

Furthermore, in the aforementioned embodiments, the flash memory 110 may also possess a data cache process and function. By employing the data cache process, it is possible to perform the merging and writing process and utilize the SLC to receive and temporarily store the next data coming from the flash memory controller 105 at the same time, which improves the overall data access efficiency. Please refer to FIG. 8A in conjunction with FIG. 8B. FIG. 8A is a timing diagram illustrating a data writing process of the flash memory apparatus 100 shown in FIG. 1 that writes data without a data cache process according to an embodiment of the present invention. FIG. 8B is a timing diagram illustrating a data writing process of the flash memory apparatus 100 shown in FIG. 1 that writes data through a data cache process according to an embodiment of the present invention. As shown in FIG. 8A, when the host terminal 115 transfers and writes one data into the flash memory controller 1051 through the time period R1, the flash memory 110 starts the first merging and writing process at the same time, to copy and write the LSB data of the previous data into the TLC from the SLC before the time period B0. After the end of R1, the flash memory controller 105 writes the stored data (transferred at the time corresponding to R1) into the SLC of the flash memory 110, where the required time period is Y1. Meanwhile, after the end of R1, the flash memory controller 105 also receives and temporarily stores the next 16 KB data coming from the host terminal 115 (the required time period for transferring and writing the data is marked as R2). After the end of Y1, the flash memory 110 starts the copy back program to execute the second merging and writing process to merge and write the CSB of the previous data into the TLC, where the required time period is marked as B0′. After the end of B0′, the SLC of the flash memory 110 then stores one data coming from the flash memory controller 105, where the required time period for transferring and writing the data is marked as Y2. After the end of Y2, the host terminal 115 transfers and writes the next 16 KB data into the buffer 1051; meanwhile, the flash memory 110 starts the copy back program at time B0″ to execute the third merging and writing process. After the end of B0″, one 16 KB data coming from the flash memory controller 105 is received and then stored into the SLC of the flash memory 110. In the embodiment shown in FIG. 8B, the time period Y2 for the SLC of the flash memory 110 to store one data coming from the flash memory controller 105 overlaps with a part of the required time period B0′ for the flash memory 110 to execute the copy back program to perform the second merging and writing process. In addition, the time period Y3 for the SLC of the flash memory 110 to store one data coming from the flash memory controller 105 overlaps with a part of the required time period B0″ for the flash memory 110 to execute the copy back program to perform the third merging and writing process. The following time period Y5 also overlaps with a part of the required time period B1′ for the second merging and writing process. In other words, the flash memory 110 caches the data obtained by performing the copy back program of the second merging and writing process through the data cache operation, and therefore can substantially simultaneously (simultaneously or slightly later) store the data into the SLC of the flash memory 110. Thus, the time period Y2 overlaps with a part of the time period B0′. Similarly, the flash memory 110 caches the data obtained by performing the copy back program of the third merging and writing process through the data cache operation, and therefore can substantially simultaneously (simultaneously or slightly later) store the data into the SLC of the flash memory 110. Thus, the time period Y3 overlaps with a part of the time period B0″. Similarly, the time period Y5 overlaps with a part of the time period B1′. The processing time periods are allowed to partially overlap with each other. Therefore, for the overall data access, the overall processing time is reduced and the overall data access efficiency is improved.

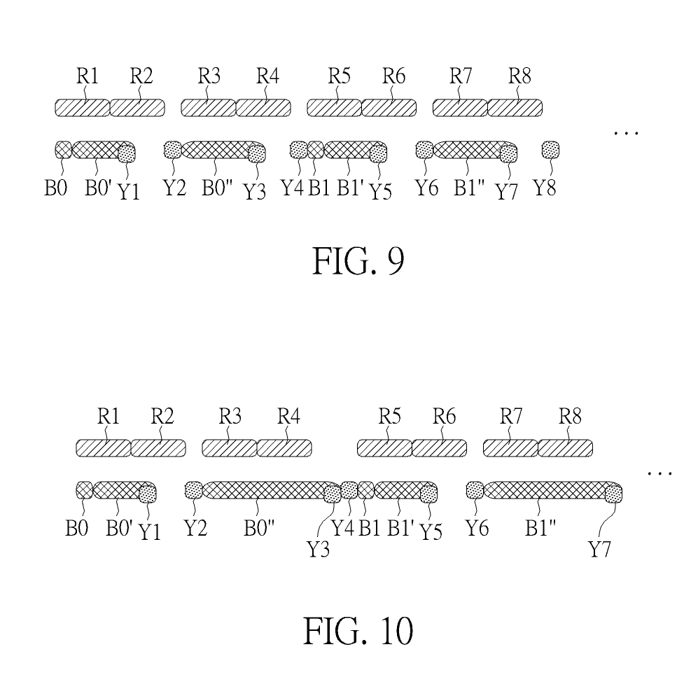

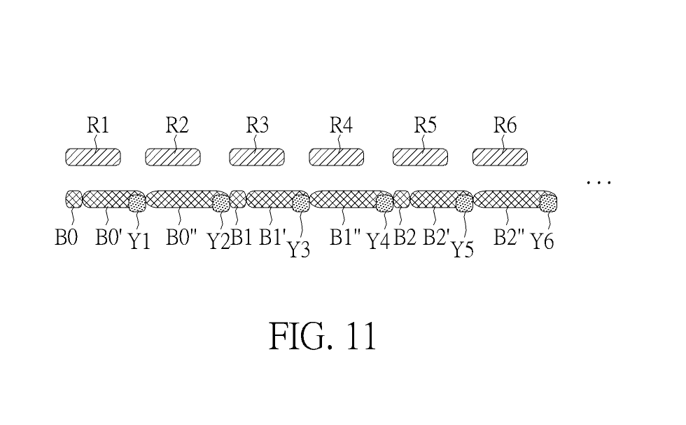

In the aforementioned embodiments, the data cache process is to cache the data obtained by performing the second and the third merging and writing processes of the copy back program, so as to allow the data storing process and the copy back program to be performed substantially simultaneously (simultaneously or slightly later) upon the SLC of the flash memory 110. However, this is not a limitation of the present invention. In another embodiment, it is also feasible to cache the data obtained by performing the first merging and writing process of the copy back program, so as to allow the data storing process and the copy back program to be performed substantially simultaneously (simultaneously or slightly later) upon the SLC of the flash memory 110. Moreover, the aforementioned data cache operation may result in different timing diagrams of data writing process due to different implementations of the flash memory 110. For instance, please refer to FIG. 9 to FIG. 11, which are timing diagrams illustrating data writing processes of the flash memory apparatus 100 shown in FIG. 1 according to different embodiments of the present invention. As illustrated by the embodiments shown in FIGS. 9-11, the data cache process is to cache the data obtained by performing the second or the third merging and writing process of the copy back program, so as to allow the data storing process and the copy back program to be performed substantially simultaneously (simultaneously or slightly later) upon the SLC of the flash memory 110. Therefore, as shown in the embodiment in FIG. 9, the data writing time periods Y1, Y3, Y5, Y7 of the SLC of the flash memory 110 overlap with the required time periods B0′, B0″, B1′, B1″ for different merging and writing processes of the copy back program, respectively. As shown in the embodiment in FIG. 10, the data writing time periods Y1, Y3, Y5, Y7 of the SLC of the flash memory 110 also overlap with the required time periods B0′, B0″, B1′, B1″ for different merging and writing processes of the copy back program, respectively. The difference between embodiments of FIG. 9 and FIG. 10 is that the required time of the third merging and writing process employed by the embodiment shown in FIG. 10 is longer than that in FIG. 9. As shown in the embodiment in FIG. 11, the data writing time periods Y1, Y2, Y3, Y4, Y5, Y6 of the SLC of the flash memory 110 also overlap with the required time periods B0′, B0″, B1′, B1″, B2′, B2″ for different merging and writing processes of the copy back program, respectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data access method for a flash memory, comprising:
receiving a first data from a host terminal by utilizing a flash memory controller;
transmitting and writing the first data into a single-level cell of the flash memory from the flash memory controller; and
when the flash memory controller receives a second data from the host terminal, utilizing the flash memory controller to execute a copy back program to merge at least a portion of the first data stored in the single-level cell into a multi-level cell.

2. The data access method of claim 1, wherein the step of utilizing the flash memory controller to execute the copy back program comprises:
copying the at least a portion of the first data stored in the single-level cell to a buffer of the flash memory; and
reading the at least a portion of the first data from the buffer of the flash memory and then writing into the multi-level cell without buffering the first data via the flash memory controller.

3. The data access method of claim 1, further comprising:
after merging the at least a portion of the first data stored in the single-level cell into the multi-level cell, writing the second data received from the host terminal into the single-level cell from the flash memory controller.

4. The data access method of claim 3, wherein the multi-level cell is a triple-level cell, and the at least a portion of the first data is at least one of a least significant bit (LSB), a central significant bit (CSB) and a most significant bit (MSB) of the first data.

5. The data access method of claim 1, wherein the multi-level cell is a triple-level cell, and the step of merging the at least a portion of the first data stored in the single-level cell into the multi-level cell comprises:
merging at least one of a least significant bit, a central significant bit and a most significant bit of the first data stored in the single-level cell into the triple-level cell.

6. The data access method of claim 1, further comprising:
when the flash memory controller receives the second data from the host terminal, transmitting and writing the first data into the single-level cell of the flash memory from the flash memory controller, and then utilizing the flash memory controller to merge the at least a portion of the first data stored in the single-level cell into the multi-level cell.

7. The data access method of claim 1, wherein a time point when the flash memory controller receives the second data from the host terminal is substantially the same as a time point when the flash memory controller executes the copy back program to merge the at least a portion of the first data stored in the single-level cell into the multi-level cell.

8. The data access method of claim 1, wherein the first data and the second data correspond to different write commands of the host terminal, respectively.

9. A flash memory apparatus, comprising:
a flash memory, arranged for storing data; and
a flash memory controller, coupled to the flash memory, the flash memory controller arranged for receiving a first data from a host terminal, and transmitting and writing the first data from the flash memory controller into a single-level cell of the flash memory;
wherein when the flash memory controller receives a second data from the host terminal, the flash memory controller executes a copy back program to merge at least a portion of the first data stored in the single-level cell into a multi-level cell.

10. The flash memory apparatus of claim 9, wherein the flash memory controller copies the at least a portion of the first data stored in the single-level cell to a buffer of the flash memory, and reads the at least a portion of the first data from the buffer of the flash memory and writes into the multi-level cell without buffering the first data via the flash memory controller.

11. The flash memory apparatus of claim 9, wherein after merging the at least a portion of the first data stored in the single-level cell into the multi-level cell, the copy back program immediately writes the second data received from the host terminal into the single-level cell.

12. The flash memory apparatus of claim 11, wherein the multi-level cell is a triple-level cell, and the at least a portion of the first data is at least one of a least significant bit (LSB), a central significant bit (CSB) and a most significant bit (MSB) of the first data.

13. The flash memory apparatus of claim 9, wherein the multi-level cell is a triple-level cell, and the flash memory controller performs the copy back program to merge at least one of a least significant bit, a central significant bit and a most significant bit of the first data stored in the single-level cell into the triple-level cell.

14. The flash memory apparatus of claim 9, wherein when the flash memory controller receives the second data from the host terminal, the flash memory controller transmits and writes the first data into the single-level cell of the flash memory, and then merges the at least a portion of the first data stored in the single-level cell into the multi-level cell.

15. The flash memory apparatus of claim 9, wherein a time point when the flash memory controller receives the second data from the host terminal is substantially the same as a time point when the flash memory controller executes the copy back program to merge the at least a portion of the first data stored in the single-level cell into the multi-level cell.

16. The flash memory apparatus of claim 9, wherein the first data and the second data correspond to different write commands of the host terminal, respectively.
